(19) United States
(12) Patent Application Publication
(10) Pub. No.: US 2016/0048855 A1
(43) Pub. Date: Feb. 18, 2016

(54) MULTIVARIATE TESTING FOR CONTENT DISCOVERY SYSTEMS

(71) Applicant: TiVo Inc., Alviso, CA (US)

(72) Inventors: Christopher Ambrozic, Alviso, CA (US); Ives Chor, Alviso, CA (US); Matthew Berry, Alviso, CA (US)

(21) Appl. No.: 14/827,237

(22) Filed: Aug. 14, 2015

Related U.S. Application Data
(60) Provisional application No. 62/037,601, filed on Aug. 14, 2014.

(51) Int. Cl. G06Q 30/02; H04L 12/26

(52) U.S. Cl. CPC G06Q 30/0203; H04L 43/16

(57) ABSTRACT

A system and methods are provided for analyzing user interactions with a media content discovery system using statistical hypothesis testing techniques. As used herein, a media content discovery system generally represents any service that enables users to browse, view, record, purchase, and/or otherwise interact with media content. Examples of media content that may be made available to users via a media content discovery system include, without limitation, movies, television shows, music, etc. Users may interact with a media content discovery system using any of a number of different types of computing devices, including set-top boxes, desktop computers, laptops, handheld devices, game consoles, etc., and over one or more networks, such as the Internet.

### PRIORITY CLAIM

This application claims benefit of Provisional Appln. 62/037,601, filed Aug. 14, 2014, the entire contents of which is hereby incorporated by reference as if fully set forth herein, under 35 U.S.C. §119(e).

### TECHNICAL FIELD

The present invention relates generally to a system and methods for multivariate testing of user interactions with a media content discovery system.

### BACKGROUND

Many businesses use some form of statistical hypothesis testing to experiment with and gauge efforts to influence customer behavior. For example, a business that sells products through a website may use statistical hypothesis testing in an effort to measure the effect of various modifications to one or more pages of the website on website visitors. The effect may be measured, for example, in terms of the number of website page views, product sales, and/or other outcomes of interest to the business.

One type of statistical hypothesis testing commonly used is referred to as “univariate A/B testing.” An A/B test is a process in which two alternate versions (e.g., an “A” version and a “B” version) of some item are tested against one another. For example, the business described above that sells products through a website may desire to determine if modifying a particular element of a product order webpage (e.g., the size of the order button) increases the likelihood that customers complete an order once the customers arrive at the product order webpage. In this example, an A/B experiment may be designed where the website's current product order webpage is designated as the “A” version, while a modified version of the same product order webpage (e.g., displaying a larger order button) is designated as the “B” version. As customers visit the product order webpage, one of the two different versions may be presented to the customers at random and various statistics may be collected for each version (e.g., whether an order was completed). Based on the results of the test, the business may then choose to use one version of the webpage or the other depending on which version of the webpage was associated with a greater rate of order completion.

While A/B testing is useful for comparing two alternate versions of some aspect of a customer's experience, businesses may desire to conduct more sophisticated tests that take into account multiple aspects of a customer's experience simultaneously. However, testing and measuring several different aspects simultaneously quickly becomes a complicated task as the number of variables increases. Furthermore, the aspects of customer experiences which a business may desire to investigate can involve data that is spread across a number of disparate data sources (e.g., a product listings database, user interface code, an email system, etc.), and integrating each of these data sources into a single application that coordinates experimentation is challenging.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF DRAWINGS

The present invention is illustrated by way of example, and not by way of limitation, in the figures of the accompanying drawings and in which like reference numerals refer to similar elements and in which:

FIG. 1 is a block diagram of an example system that implements multivariate testing of user interactions with a media content discovery system in accordance with one or more embodiments;

FIG. 2A depicts an example flow for creating and configuring a multivariate experiment in accordance with one or more embodiments;

FIG. 2B depicts an example flow for performing and analyzing the results of a multivariate experiment in accordance with one or more embodiments; and

FIG. 3 is a block diagram illustrating a system upon which an embodiment of the invention may be implemented.

### DETAILED DESCRIPTION

Example embodiments, which relate to a system for multivariate testing of user interactions with a media content discovery system, are described herein. In the following description, for the purposes of explanation, numerous specific details are set forth in order to provide a thorough understanding of the present invention. It will be apparent, however, that the present invention may be practiced without these specific details. In other instances, well-known structures and devices are not described in exhaustive detail, in order to avoid unnecessarily occluding, obscuring, or obfuscating the present invention.

Example embodiments are described herein according to the following outline:

1.0 General Overview

2.0 Structural Overview

3.0 Functional Overview
3.1 Selecting Dimensions for Investigation
3.2 Configuring Experiment Settings
3.3 Selecting a Test User Population and Experiment Window
3.4 Generating Experiment Permutations
3.5 Performing an Experiment
3.6 Analyzing Experiment Results
3.7 Auto-Optimization of Experiments

4.0 Implementation Mechanism—Hardware Overview

5.0 Extensions and Alternatives

### 1.0 GENERAL OVERVIEW

This overview presents a basic description of some aspects of an embodiment of the present invention. It should be noted that this overview is not an extensive or exhaustive summary of aspects of the embodiment. Moreover, it should be noted that this overview is not intended to be understood as identifying any particularly significant aspects or elements of the embodiment, nor as delineating any scope of the embodiment in particular, nor the invention in general. This overview merely presents some concepts that relate to the example embodiments in a condensed and simplified format, and should be understood as merely a conceptual prelude to a more detailed description of example embodiments that follows below.

Embodiments described herein relate to a system and methods for analyzing user interactions with a media content discovery system using statistical hypothesis testing techniques. As used herein, a media content discovery system generally refers any service that enables users to browse, view, record, purchase, and/or otherwise interact with media content. Examples of media content that may be made available by a media content discovery system include, without limitation, movies, television shows, music, etc. Users may interact with a media content discovery system using any of a number of different types of computing devices, including set-top boxes, desktop computers, laptops, handheld devices, game consoles, etc., and may access the media content discovery system over one or more networks, such as the Internet.

In this context, statistical hypothesis testing generally involves creating and performing “experiments” in an effort to measure what effect, if any, various modifications to one or more aspects of a media content discovery system have on one or more desired outcomes. As one example, an outcome of interest for a provider of a media content discovery system may include whether or not users of the media content discovery system purchase a promoted media content item in response to the display of advertisements for the content item. In this example, a statistical hypothesis experiment may be designed to measure an effect that some modification to the displayed advertisements (e.g., different sizes, graphics, placement, etc.) has on customer purchases of the promoted items.

As indicated, one particular type of statistical hypothesis testing used to conduct such experiments is referred to as univariate A/B testing. An experiment based on univariate A/B testing measures two different versions of some aspect, or “dimension,” of a system against one another. For example, in a media content discovery system, one dimension of interest may be particular media content items that are promoted in advertisements displayed to end users. In this example, a univariate A/B experiment may be designed where a first version of an advertisement is created promoting a particular media content item (e.g., “Movie A”), and a second version of the same advertisement is created promoting a different media content item (e.g., “Movie B”). To perform this example univariate A/B testing experiment, each of the two versions of the advertisement may be displayed to a subset of the general user population, and information may be recorded indicating whether users purchased the advertised content item in response to viewing one advertisement or the other. Analysis of the experiment results may indicate, for example, that a significant number of users purchased the advertised movie promoted in one of the two advertisements relative to the other. In response to this discovery, the “winning” advertisement may then be more heavily promoted to the general user population relative to the other advertisement based on an assumption that it is more effective in generating user purchases.

The example above illustrates a univariate A/B experiment that measures a test user population's response to two different versions of a single dimension of a media content discovery system, and further illustrates application of the experiment results to a broader population of users. However, conclusions inferred from a univariate A/B experiment conducted on a test population may not always translate as expected to a broader user population. For example, one reason results from a univariate A/B experiment may not translate to a broader user population is that the experiment may not have taken into account additional dimensions that have a significant influence on the tests users' behavior. In the example described above, variables such as a type of device (e.g., a television or a handheld computing device) on which each advertisement was displayed, or the presence other simultaneous marketing efforts for the content items (e.g., email advertisements, physical mail promotions, billboards, etc.), may have played a significant role in influencing the observed user behavior.

In one embodiment, in order to enable users to develop more sophisticated experiments that account for multiple dimensions simultaneously, univariate A/B testing may be expanded to multiple variables, referred to as multivariate testing. For example, to expand the example experiment described above to a multivariate experiment, a dimension corresponding to a type of device (e.g., a television or a handheld computing device) upon which each advertisement is displayed may also be included in an experiment. The example multivariate experiment now includes four different combinations or “tests”: a promotion “A” displayed on a television, promotion “A” displayed on a handheld device, a promotion “B” displayed on a television, and promotion “B” displayed on a handheld device. Each of these four tests may be presented to a test population of media content discovery system users and a success rate for each test recorded, the results of which may provide a more nuanced understanding of which dimensions and dimension values have the most significant effect on user behavior.

The example experiment described above includes two dimensions, each dimension having two possible dimension values. However, the techniques described herein generally enable creation and performance of experiments that involve virtually any number of dimensions and dimension values. In the context of a media content discovery system, example dimensions that may be investigated include, without limitation, different types of advertisements, marketing campaigns, user interface layouts and designs, content item pricing, or any other aspect of the system that may affect user behavior. By enabling users to create and perform multivariate experiments which take into account multiple dimensions and dimension values, cause and effect relationships between various dimensions can be more accurately measured and better used to inform decisions about the design of the system.

In one embodiment, first input is received selecting two or more dimensions associated with a media content discovery system. For each of the two or more dimensions, second input is received indicating two or more dimension values. Based on the two or more dimension values for each of the two or more selected dimensions, a plurality of experiment permutations are generated. One or more instances of each experiment permutation of the plurality of experiment permutations is sent to a media device of a plurality of media content devices. For each of the one or more instances, it is determined whether a user takes a particular action associated with the instance.

Various modifications to the preferred embodiments and the generic principles and features described herein will be readily apparent to those skilled in the art. Thus, the disclosure is not intended to be limited to the embodiments shown, but is to be accorded the widest scope consistent with the principles and features described herein.

### 2.0 SYSTEM ARCHITECTURE

Although a specific computer architecture is described herein, other embodiments of the invention are applicable to any architecture that can be used to perform the functions described herein.

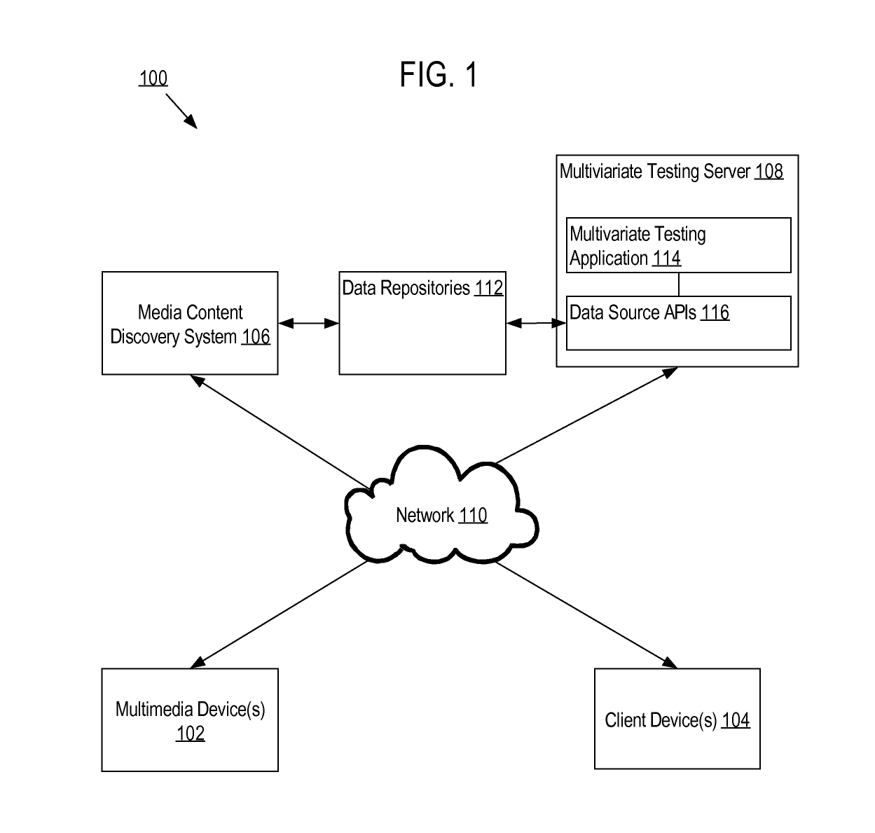

FIG. 1 is a block diagram illustrating an example networked computer environment in which an embodiment may be implemented. Although a specific system is described, other embodiments are applicable to any system that can be used to perform the functionality described herein.

Components of the system 100 may be connected via one or more networks (e.g., network 110). Network 110 may be implemented by any medium or mechanism that provides for the exchange of data between components of the system 100. Examples of network 110 include, without limitation, a network such as a Local Area Network (LAN), Wide Area Network (WAN), wireless network, the Internet, Intranet, Extranet, etc., or combinations thereof. Any number of devices within the system 100 may be directly connected to each other through wired or wireless communication segments.

In an embodiment, the system 100 includes one or more multimedia devices (e.g., multimedia device(s) 102), one or more client devices (e.g., client device(s) 104), a media content discovery system 106, a multivariate testing server 108, and data repositories 112.

In an embodiment, a multimedia device 102 generally represents a device capable of interacting with media content available from one or more media content discovery systems (e.g., media content discovery system 106) and/or other content sources. Examples of multimedia device 102 include, without limitation, a digital video recorder (DVR), media server, set-top box, digital media receiver, tablet computer, etc. Multimedia device 102 may include one or more tuners configured to receive media content from content sources. A tuner may refer to, but is not limited to, any of: a cablecard, an audio tuner, a video tuner, an audiovisual tuner, a system resource unit, a system component, a signal processing unit, etc. which can be provisioned, tuned, allocated, assigned, used, etc., (e.g., on demand, in advance, etc.) by the multimedia device 102 to receive media programs from media content discovery system 106 and/or other content sources.

Media content discovery system 106 is a system of one or more server computing devices that collectively implement a service which enables users to search for and consume media content, use content recommendation services, and perform other operations.

In one embodiment, multivariate testing server 108 comprises a multivariate testing application 114 and data source application programming interfaces (APIs) 116. Multivariate testing server 108 is a system of one or more server computing devices, such as web servers, application servers, and/or database servers that collectively implement components 114 and 116. In an embodiment, multivariate testing server 108 may be operated by a multivariate testing services provider, or may be owned and operated by the provider of media content discovery system 106.

In an embodiment, multivariate testing server 108 comprises a multivariate testing application 114 which receives input from users to design multivariate experiments, causes performance of designed multivariate experiments, and analyzes and presents the results of experiments. In one embodiment, multivariate testing application 114 comprises a web-based application that provides one or more graphical user interfaces for designing multivariate experiments and displaying experiment results.

In one embodiment, multivariate testing server 108 further comprises data sources APIs 116 component which enables multivariate testing application 114 to access data stored in data repositories 112. In an embodiment, data repositories 112 are configured to collect and store information related to various components of media content discovery system 106. Examples of data repositories 112 include, for example, one or more media content item libraries, content item pricing databases, user interface repositories, email system data, and/or any other information related to media content discovery system 106.

A client device 104 is a client computing device, or component thereof, that enables a user to interact with multivariate testing server 108. Client device 104 may be, for example, a web browser, an application, an operating system, a device that executes the foregoing, or any combination thereof. In one embodiment, client device 104 may comprise a web browser that enables a user to access a web-based application hosted by multivariate testing server 108.

### 3.0 FUNCTIONAL OVERVIEW

In an embodiment, each of the processes described in this section may be implemented using one or more computer programs, other software elements, and/or digital logic in any combination of general-purpose computing devices or a special-purpose computing devices, while performing data retrieval, transformation, and storage operations that involve interacting with and transforming the physical state of memory of the computing devices(s). In some embodiments, the processes are implemented in a system comprising a client computing device, such as a personal computer or mobile device, and one or more servers, such as a web server and/or an application server. A server, as used herein, is a system of one or more computing devices that collectively operate to provide various functionalities described herein. In other embodiments, the processes are implemented exclusively by one or more servers or by a single client computing device. Specific examples of such systems are described in the preceding sections.

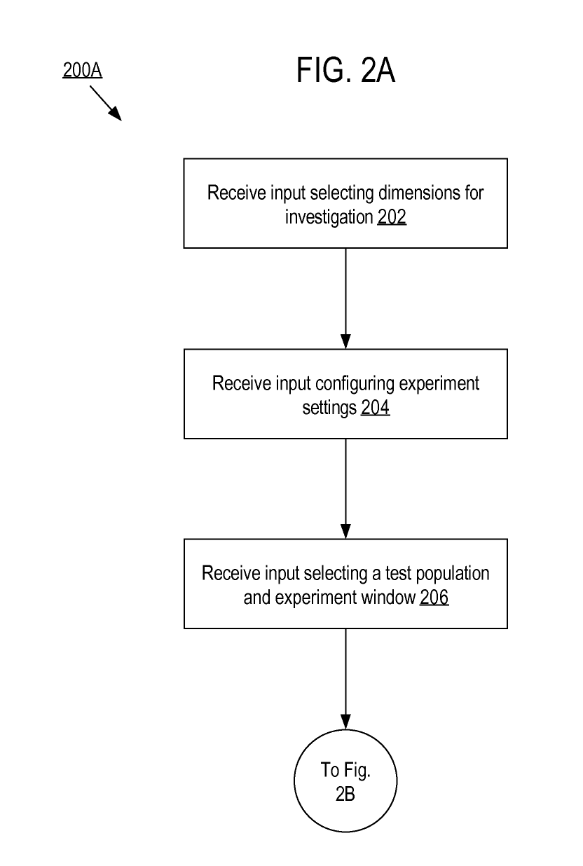

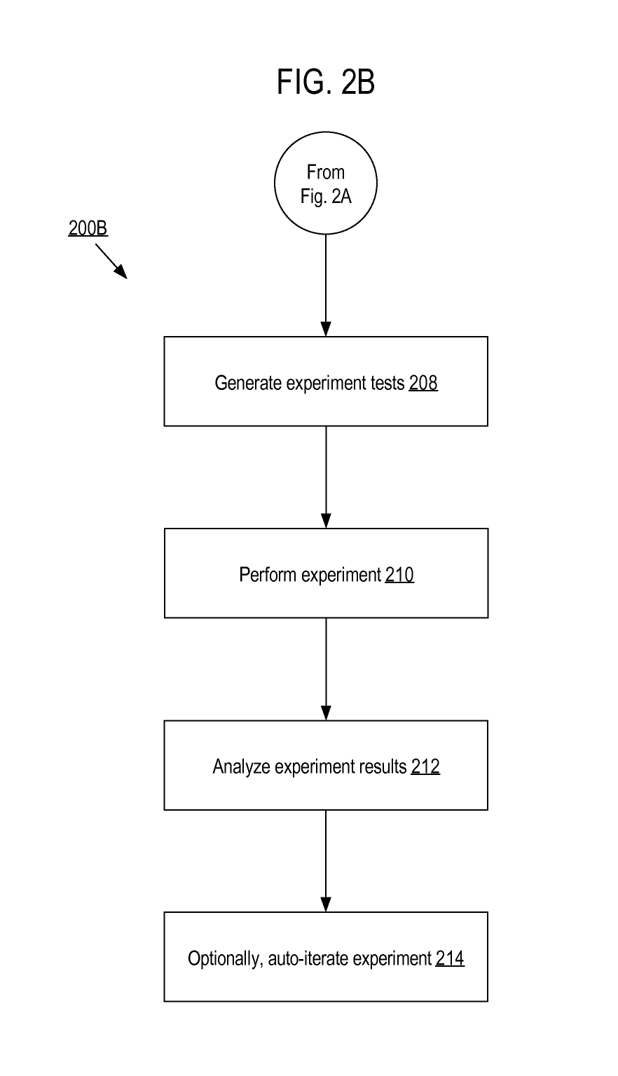

FIG. 2A depicts an example flow 200A for designing a multivariate experiment for a media content discovery system, in accordance with one or more embodiments. FIG. 2B depicts an example flow 200B for performing and analyzing the results of a designed multivariate experiment, in accordance with one or more embodiments.

3.1 Selecting Dimensions for Investigation

Referring to FIG. 2A, in step 202, input is received selecting one or more dimensions of a content discovery system for investigation. In this context, dimensions of a content discovery system generally include any component or aspect of the content discovery system that can be modified in some way. Examples of dimensions include, without limitation, one or more graphical user interfaces, advertisements for content items displayed at a multimedia device, marketing campaigns (e.g., email marketing campaigns), content item pricing, etc.

In one embodiment, a user may provide input selecting one or more dimensions for investigation using one or more graphical user interfaces generated by a client device 104, which in turn may send the user selections to multivariate testing application 114. For example, a user may use a web browser or other application hosted by client device 104 and that communicates with multivariate testing application 114. As another example, multivariate testing application 114 may be configured as a standalone application capable of execution on a client device 104.

3.2 Configuring Experiment Settings

In step 204, input is received to configure one or more experiment settings, including configuration of two or more dimension values for each of the dimensions selected in step 202. For example, if one of the dimensions selected in step 202 is particular content items displayed in advertisements shown on multimedia devices 102, the received input may include dimension values corresponding to two or more particular content items a user desires to measure against one another. As another example, if one of the selected dimensions is the layout of a particular graphical user interface, the input may include values corresponding to alternative graphical user interface layouts for comparison.

In an embodiment, one or more selected dimensions may be associated with a data sources API 116 that enables multivariate testing application 114 to access information stored in data repositories 112. For example, if one of the dimensions is particular content items displayed in advertisements, this dimension may be associated with an API that enables multivariate testing application 114 to search for and retrieve information from a database of available media content items. As another example, if a selected dimension is a particular graphical user interface, an associated API may enable users to make changes to one or more GUIs of interest, the data for which is stored in a data repository 112.

In one embodiment, possible dimension values for one or more of the selected dimensions may be retrieved from data repositories 112 via data sources APIs 116 or other means and presented to the user for selection. For example, if one of the dimensions under investigation is pricing for content items displayed in advertisements, a content item pricing database may be queried for possible price points for the content items. The possible price points retrieved from the content item pricing database may then be presented to the user for selection as dimension values.

In an embodiment, configuring experiment settings may also include defining one or more outcomes of interest for the experiment. Using the example above of an experiment involving advertisements for particular media content items, an outcome of interest may be a “click-through rate” for the advertisement, or whether users take some other action related to the advertisement such as purchasing the advertised media content item. As another example, if an experiment involves a dimension corresponding to an email marketing campaign advertising a new service, an outcome of interest may be whether or not targeted users register for the advertised service. As described in more detail hereinafter, performance of an experiment by multivariate testing application 114 may include detecting and collecting information about occurrences of an outcome of interest when users are presented with test instances of the experiment.

3.3 Selecting a Test User Population and Experiment Window

In step 206, input is received selecting a test user population and an experiment window defining one or more timespans for performing the experiment under design. In one embodiment, selection of a test user population may involve receiving input selecting a particular number of users (e.g., 1000 users) or percentage of the total user population (e.g., 10% of the total number of users). Selecting a test user population may include selecting particular individual users of interest. In general, any grouping of users of the media content discovery system 106 may be selected for experimentation depending on user preferences and/or the nature of the experiment.

In one embodiment, selecting a test user population may include defining and selecting one or more “user clusters.” In this context, a user cluster represents a grouping of users that share some common quality or characteristic. A user cluster generally may be based on any information associated with users including user profile information (e.g., age, gender, location, favorite shows), historical media content consumption habits, or any other information. As one example, if a user is designing an experiment that tests two or more variations of advertisements for a cartoon movie, a user cluster may be defined that includes users that frequently watch cartoons based on historical viewing habits tracked by media content discovery system 106. By targeting an experiment to a defined cluster of users having characteristics that are relevant to the experiment, the results of the experiment may be considered more accurate.

As indicated above, a user may also select an experiment window defining one or more periods of time during which to perform the experiment. For example, a user may provide input indicating that the experiment is to be performed from 5 pm-midnight on the upcoming Friday night. As another example, a user may specify an experiment window corresponding to the next two weekends, for the entirety of the next month, or beginning tomorrow and continuing indefinitely. In an embodiment, if a user does not explicitly define an experiment window, an experiment may run until the user provides input to end the experiment. The specified experiment window generally indicates a time period during which multivariate testing application 114 and/or media content discovery system 106 presents the tests generated for the designed experiment to the selected test population, as described in more detail hereinafter.

In one embodiment, the multivariate testing application 114 may analyze the provided experiment setting inputs to identify potential obstacles in collecting sufficient data to provide statistically significant results. For example, based on a number of dimensions and dimension values specified as input in steps 202 and 204, multivariate testing application 114 may determine an approximate number of user interactions with the experiment that would result in a statistically significant sample size. Multivariate testing application 114 may also determine, based on historical user interaction data with media content discovery system 106, whether the approximated number of user interactions are likely to occur during the specified experiment window. If the multivariate testing application 114 determines that a statistically significant number of user interactions matching the specified dimensions and dimension values are not likely to occur during the specified experiment window, an alert may be presented to the user. In this manner, a user may be warned before spending time causing multivariate testing server 108 and/or media content discovery system 106 to perform experiments that are unlikely to generate useful results. In an embodiment, multivariate testing server 108 may provide suggested adjustments to the experiment settings to overcome the identified obstacles.

3.4 Generating Experiment Permutations

Referring now to FIG. 2B, in step 208, in response to the user input provided in steps 202-206 of FIG. 2A, a plurality of experiment permutations are automatically generated based on the selected dimensions and experiment settings. For example, multivariate testing application 114 may automatically generate the permutations by creating possible combinations of the selected dimensions and dimension values. In this context, each “permutation” refers to a particular instance of the generated combinations. For example, if a first dimension is a particular content item displayed in an advertisement with values corresponding to either content item X or content item Y, and a second dimension is a device type with dimension values corresponding to either a set-top box or a handheld device, then one permutation that may be automatically generated is an advertisement promoting content item X to be displayed on a set-top box; a second permutation that may be automatically generated is an advertisement promoting content item X and to be displayed on a handheld device, and so forth.

In one embodiment, a full factorial method is used to automatically generate a set of tests based on the dimensions and dimension values selected by a user. To generate tests using a full factorial method, a separate test is generated for all possible combinations of dimensions and dimension values.

In some instances, the resulting number of tests generated by a full factorial method may involve an undesirable amount time to collect a statistically significant number of user interactions with the tests. In one embodiment, multivariate testing server 108 may instead generate the tests using a “fractional” factorial method. A partial factorial experiment consists of selecting a subset of the total number of tests generated by the full factorial method. The decision as to whether to use a full factorial method or fractional factorial method may be specified by the user, or may be based on multivariate testing application 114 determining that a statistically significant number of user interactions matching the specified dimensions and dimension values are not likely to occur during the specified experiment window using the full factorial method, as described above.

3.5 Performing an Experiment

In step 210, the experiment permutations generated in step 208 are performed during the experiment window defined in step 206. In one embodiment, performing the generated experiment permutations generally involves causing media content discovery system 106 to present instances each of the experiment permutations to one or more users of the selected test user population during the experiment window, and determining whether any defined outcome of interest occurs in response to each test. For example, if an experiment involves testing different versions of an advertisement, each time media content discovery system 106 generates a screen display containing an advertisement to send to a multimedia device 102, the media content discovery system 106 may be configured to select one of the test advertisements at random or based on another selection algorithm. Multivariate testing server 108 may further detect whether each user receiving a test advertisement performs one or more actions associated with the test, such as an action that corresponds to a defined outcome of interest for the experiment.

In one embodiment, each instance of an experiment permutation may be associated with a unique uniform resource identifier (e.g., a URL) that includes one or more parameters identifying the experiment permutation. For example, the parameters for a particular experiment permutation may identify each of the dimensions and particular dimension values that define that particular experiment permutation. The parameters may be included with each test so that multivariate testing application 114 can associate user responses with the particular experiment permutation that generated the response.

In an embodiment, the tests may be presented to users of the specified test user population for the entire duration of the defined experiment window, until a statistically significant number of user interactions have occurred, and/or until a user provides input to end the experiment.

3.6 Analyzing Experiment Results

In step 212, the results of the experiment are analyzed. In one embodiment, the information collected during an experiment (e.g., the number of occurrences of each test and a number of occurrences of a user action corresponding to a defined outcome of interest) may be stored in a data repository for analysis. Any number of statistical methods may be used to analyze the information to derive conclusions from experiment data. Examples of statistical methods that may be used include, without limitation, the Yates method, multiple linear regression, or partial least squares regression. In general, by analyzing the data using one or more of the above techniques, a regression coefficient may be calculated for each dimension and dimension value pair. The regression coefficient provides an estimated measure of the effect each dimension and dimension value pair has on the likelihood that a user performs an action corresponding to a defined outcome of interest. In an embodiment, the results of an experiment may be displayed in one or more user interfaces, such as an analytics dashboard.

In one embodiment, a user may decide to implement “winning” test combinations (dimension and dimension value pairs) in the media content discovery system as a whole. To implement a particular test combination, multivariate testing application 114 may enable users to push desired changes (e.g., via a data source API 116) to the media content discovery system 106 based on the results of the experiment. For example, if an experiment comparing two different versions of a user interface indicates that one particular user interface is more successful than the other in terms of a click-through rate, multivariate testing application 114 may enable the user to push the “winning” user interface to the database from which the GUI is presented to the general population of users. The “winning” user interface may then be presented to all or a subset of the general population of users. Further, the “winning” user interface may be presented to users indefinitely, or the interface may be presented for a limited period of time.

3.7 Auto-Optimization of Experiments

In step 214, optionally, the experiment may be automatically re-performed with modified experiment settings and/or with a modified test user population. In one embodiment, the modified experiment settings and/or test user population may be specified by a user or may be automatically adjusted by multivariate testing application 114 using one or more optimization techniques.

In one embodiment, at the completion of an experiment, multivariate testing application 114 may be configured to determine whether the results of the experiment provided any statistically significant conclusions. If multivariate testing application 114 determines that the results are not statistically significant, different dimensions, dimension settings, and/or test populations may be selected and the experiment may be automatically re-performed with the adjusted settings. If instead multivariate testing application 114 determines that the results conclusively indicate that a test, multivariate testing application 114 may be configured to automatically push a “winning” test variation to the general population.

Embodiments include a computer readable storage medium, storing software instructions, which when executed by one or more processors cause performance of any one of the foregoing methods.

Embodiments include an apparatus comprising a processor and configured to perform any one of the foregoing methods.

Note that, although separate embodiments are discussed herein, any combination of embodiments and/or partial embodiments discussed herein may be combined to form further embodiments.

### 4.0 IMPLEMENTATION MECHANISMS—HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

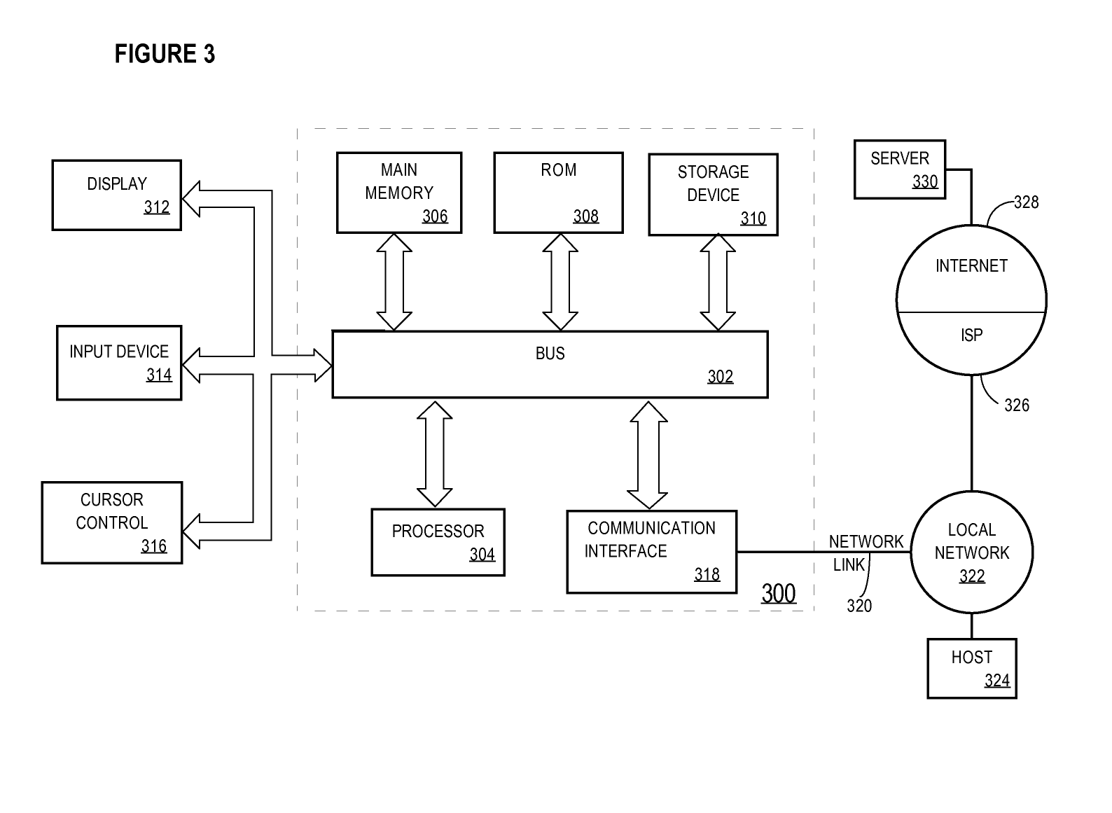

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is device-specific to perform the operations specified in the instructions.

Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a liquid crystal display (LCD), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using device-specific hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 303 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 310. Volatile media includes dynamic memory, such as main memory 306. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### 5.0 EQUIVALENTS, EXTENSIONS, ALTERNATIVES, AND MISCELLANEOUS

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method, comprising:
receiving first input selecting two or more dimensions associated with a media content discovery system;
for each of the two or more dimensions, receiving second input indicating two or more dimension values;
generating, based on the two or more dimension values for each of the two or more dimensions, a plurality of experiment permutations;
sending, to a media device of a plurality of media devices, one or more instances of each experiment permutation of the plurality of experiment permutations;
for each instance of the one or more instances, determining whether a user takes a particular action associated with the instance.

2. The method of claim 1, further comprising:
receiving third input selecting an experiment time window;
determining, based on historical user interaction data, whether a threshold number of user interactions are expected to occur during the experiment time window;
in response to determining that a threshold number of user interactions are not expected during the experiment time window, displaying an alert.

3. The method of claim 1, wherein a dimension of the plurality of dimensions corresponds to one or more of: a user interface, a user interface component, a media content item, a media content item type, content item pricing, a media device type, a time of day, a day of the week, an external marketing campaign.

4. The method of claim 1, further comprising receiving input selecting a population of users, wherein each user of the population of users is associated with a media device of the plurality of media devices.

5. The method of claim 1, further comprising receiving input selecting a population of users, the input including specification of one or more user characteristics.

6. The method of claim 1, wherein the action includes one or more of purchasing a media content item, scheduling a recording a media content item, viewing a media content item, clicking on a link.

7. The method of claim 1, further comprising:
based on at least one dimension of the two or more selected dimensions, retrieving a set of possible dimension values from a data source corresponding to the at least one dimension;
wherein the second input includes a selection of at least one dimension value from the set of possible dimension values.

8. The method of claim 1, further comprising:
based on at least one dimension of the two or more selected dimensions, retrieving a set of possible dimension values from a data source corresponding to the at least one dimension;
wherein the data source is a media content item database.

9. The method of claim 1, further comprising receiving third input selecting at least one action, the at least one action including the particular action;
wherein the at least one action includes one or more of: scheduling of a recording, selection of a media content item for viewing, an advertisement click-through, a purchase, and a user registration.

10. The method of claim 1, wherein each experiment permutation of the plurality of experiment permutations corresponds to a particular user interface display.

11. One or more non-transitory computer-readable storage media, storing instructions, which when executed by one or more processors cause:
receiving first input selecting two or more dimensions associated with a media content discovery system;
for each of the two or more dimensions, receiving second input indicating two or more dimension values;
generating, based on the two or more dimension values for each of the two or more dimensions, a plurality of experiment permutations;
sending, to a media device of a plurality of media devices, one or more instances of each experiment permutation of the plurality of experiment permutations;
for each instance of the one or more instances, determining whether a user takes a particular action associated with the instance.

12. The one or more non-transitory storage media of claim 11, further comprising:
receiving third input selecting an experiment time window;
determining, based on historical user interaction data, whether a threshold number of user interactions are expected to occur during the experiment time window;
in response to determining that a threshold number of user interactions are not expected during the experiment time window, displaying an alert.

13. The one or more non-transitory storage media of claim 11, wherein a dimension of the plurality of dimensions corresponds to one or more of: a user interface, a user interface component, a media content item, a media content item type, content item pricing, a media device type, a time of day, a day of the week, an external marketing campaign.

14. The one or more non-transitory storage media of claim 11, further comprising receiving input selecting a population of users, wherein each user of the population of users is associated with a media device of the plurality of media devices.

15. The one or more non-transitory storage media of claim 11, further comprising receiving input selecting a population of users, the input including specification of one or more user characteristics.

16. The one or more non-transitory storage media of claim 11, wherein the action includes one or more of purchasing a media content item, scheduling a recording a media content item, viewing a media content item, clicking on a link.

17. The one or more non-transitory storage media of claim 11, further comprising:
based on at least one dimension of the two or more selected dimensions, retrieving a set of possible dimension values from a data source corresponding to the at least one dimension;
wherein the second input includes a selection of at least one dimension value from the set of possible dimension values.

18. The one or more non-transitory storage media of claim 11, further comprising:
based on at least one dimension of the two or more selected dimensions, retrieving a set of possible dimension values from a data source corresponding to the at least one dimension;
wherein the data source is a media content item database.

19. The one or more non-transitory storage media of claim 11, further comprising receiving third input selecting at least one action, the at least one action including the particular action;
wherein the at least one action includes one or more of: scheduling of a recording, selection of a media content item for viewing, an advertisement click-through, a purchase, and a user registration.

20. The one or more non-transitory storage media of claim 11, wherein each experiment permutations of the plurality of experiment permutations corresponds to a particular user interface display.

21. An apparatus, comprising:
a subsystem, implemented at least partially in hardware, that receives first input selecting two or more dimensions associated with a media content discovery system;
a subsystem, implemented at least partially in hardware, that for each of the two or more dimensions, receives second input indicating two or more dimension values;
a subsystem, implemented at least partially in hardware, that generates, based on the two or more dimension values for each of the two or more dimensions, a plurality of experiment permutations;
a subsystem, implemented at least partially in hardware, that sends, to a media device of a plurality of media devices, one or more instances of each experiment permutations of the plurality of experiment permutations;
a subsystem, implemented at least partially in hardware, that for each instance of the one or more instances, determines whether a user takes a particular action associated with the instance.

22. The apparatus of claim 21, further comprising:
a subsystem, implemented at least partially in hardware, that receives third input selecting an experiment time window;
a subsystem, implemented at least partially in hardware, that determines, based on historical user interaction data, whether a threshold number of user interactions are expected to occur during the experiment time window;
a subsystem, implemented at least partially in hardware, that in response to determining that a threshold number of user interactions are not expected during the experiment time window, displays an alert.

23. The apparatus of claim 21, wherein a dimension of the plurality of dimensions corresponds to one or more of: a user interface, a user interface component, a media content item, a media content item type, content item pricing, a media device type, a time of day, a day of the week, an external marketing campaign.

24. The apparatus of claim 21, further comprising a subsystem, implemented at least partially in hardware, that receives input selecting a population of users, wherein each user of the population of users is associated with a media device of the plurality of media devices.

25. The apparatus of claim 21, further comprising a subsystem, implemented at least partially in hardware, that receives input selecting a population of users, the input including specification of one or more user characteristics.

26. The apparatus of claim 21, wherein the action includes one or more of purchasing a media content item, scheduling a recording a media content item, viewing a media content item, clicking on a link.

27. The apparatus of claim 21, further comprising:
a subsystem, implemented at least partially in hardware, that based on at least one dimension of the two or more selected dimensions, retrieves a set of possible dimension values from a data source corresponding to the at least one dimension;
wherein the second input includes a selection of at least one dimension value from the set of possible dimension values.

28. The apparatus of claim 21, further comprising:
a subsystem, implemented at least partially in hardware, that based on at least one dimension of the two or more selected dimensions, retrieves a set of possible dimension values from a data source corresponding to the at least one dimension;
wherein the data source is a media content item database.

29. The apparatus of claim 21, further comprising a subsystem, implemented at least partially in hardware, that receives third input selecting at least one action, the at least one action including the particular action;
wherein the at least one action includes one or more of: scheduling of a recording, selection of a media content item for viewing, an advertisement click-through, a purchase, and a user registration.

30. The apparatus of claim 21, wherein each experiment permutations of the plurality of experiment permutations corresponds to a particular user interface display.
